(19) United States
(12) Patent Application Publication
(10) Pub. No.: US 2026/0165287 A1
(43) Pub. Date: Jun. 18, 2026

(54) Cat Litter Containing Sustained Viability Probiotic

(71) Applicant: Boxiecat LLC, Santa Monica, CA (US)

(72) Inventors: Alvin Kershman, St. Louis, MO (US); Jeff Shear, Bonita Springs, FL (US); Harold Cole, St. Louis, MO (US)

(73) Assignee: Boxiecat LLC, Santa Monica, CA (US)

(21) Appl. No.: 19/399,204

(22) Filed: Nov. 24, 2025

Related U.S. Application Data
(60) Provisional application No. 63/733,467, filed on Dec. 13, 2024.

(51) Int. Cl. A01K 1/015

(52) U.S. Cl. CPC A01K 1/0155; A01K 1/0154

(57) ABSTRACT

A cat litter comprising an absorbent material and at least one granulated probiotic containing least one probiotic and at least one non-hygroscopic binder. The cat litter absorbent material can be granulated sodium bentonite and the granulated probiotic contains crystalline lactose as the non-hygroscopic binder in an amount of greater than 50 wt. % in the granulated probiotic.

### CROSS-REFERENCE TO RELATED APPLICATIONS

This utility patent application claims the benefit of provisional patent application 63/733,467 filed Dec. 13, 2024, which is hereby incorporated by reference.

### STATEMENT REGARDING FEDERALLY SPONSORED RESEARCH

Not Applicable.

### APPENDIX

Not Applicable.

### BACKGROUND OF THE INVENTION

### Field of the Invention

The present disclosure relates generally to compositions, and methods that use granulated non-hygroscopic material containing probiotics as a deodorant for cat litter.

### Related Art

Litter boxes are used by cats for elimination of urine and fecal matter. A litter box contains a layer of cat litter that receives the urine and fecal matter. The cat litter is granular and absorbent to facilitate formation of clumps after the urine and fecal matter is deposited in the cat litter. The clumps are typically sifted from the litter box using a litter scoop and then discarded.

It is known to add probiotics to cat litter to reduce the urine and fecal odor. There are several ways known in the art to add probiotics to cat litter. The powdered probiotics can simply be sprinkled on top of the cat litter. Alternatively, the probiotics can be coated onto the cat litter, or the probiotics can be mixed in with the cat litter material which is subsequently granulated. The known methods of adding probiotics to absorbent cat litter have the disadvantage of rapidly diminishing effectiveness of the probiotics through loss of viability. Various environmental factors such as temperature, oxygen, humidity, and pH can lower the viability of probiotics. Probiotic strains are dormant when they are in dry powder form. The addition of moisture and heat causes them to “wake up or activated” in an environment that is not suitable for their survival because of an absence of a sufficient aqueous medium and food. This leads to the death of the cells. When the cat litter is urinated or defecated on, the activated probiotic is rapidly used up and becomes no longer viable. The next time the litter box is used, there is no viable probiotic and no deodorant effect.

The present invention provides a stable, granulated form of probiotics suitable for cat litter, where the probiotic viability is sustained and preserved.

### SUMMARY OF THE INVENTION

The present invention is an improved cat litter which comprises at least one absorbent material and at least one granulated probiotic, wherein the at least one granulated probiotic contains at least one non-hygroscopic binder. In a preferred embodiment, the non-hygroscopic binder is selected from the group consisting of crystalline lactose, hydroxypropylmethylcellulose (HPMC), hydroxypropylcellulose (HPC), hydroxyethylcellulose, methylcellulose and/or ethylcellulose. In a preferred embodiment, the at least one granulated probiotic does not contain hygroscopic clay, which would attract water and damage the probiotic.

In another embodiment of the invention, the granulated probiotic has a coating that provides a slow release of the probiotic.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

The claimed pet litter comprises at least one absorbent material and at least one granulated non-hygroscopic binder-containing probiotics. The absorbent material can be any absorbent material or combination of absorbent materials commonly used in litters. Typically, the absorbent material is a dry, granular material. Preferably, said absorbent material is selected from the group consisting of clays, silica gels, woods (such as pine, aspen, cedar, fir, spruce), agricultural products, and combinations thereof. More preferably, said absorbent material is selected from the group consisting of clays, silica gels, pumice, absorbent foamed materials, and combinations thereof. In a particular embodiment, the absorbent material is clay, such as calcium or sodium montmorillonite (including sodium bentonite and calcium bentonite), smectite, ventriculite, attapulgite, opal clay and/or kaolin. The absorbent material, in particular clays, can be clumping and/or non-clumping.

The at least one granulated probiotic contains at least one non-hygroscopic binder and at least one probiotic. The term “non-hygroscopic polymer” herein means that the compound and/or polymer exhibits an equilibrium moisture uptake at 40% relative humidity of not more than about 8%, preferably not more than about 7%, and more preferably not more than about 6%, for example about 1% to about 5%. The non-hygroscopic polymer can be cellulosic or non-cellulosic. In an embodiment, the polymer is a cellulosic polymer, for example, hydroxypropylmethylcellulose (HPMC), hydroxypropylcellulose (HPC), hydroxyethylcellulose, methylcellulose and/or ethylcellulose. Because the non-hygroscopic polymer does not attract moisture, it helps sustain the viability of the probiotic bacteria, which is deteriorated by moisture. A preferred non-hygroscopic material is crystalline lactose. A preferred amount of non-hygroscopic material in the granulated probiotic is from about 10 to 95 wt. %. A more preferred range is from 30 to 90 wt. %. Another preferred amount is greater than 50 wt. %. Another preferred range is from about 65 to 95 wt. %.

The probiotic can be selected from a wide variety of bacteria and mixtures of bacteria. A number of urease negative organisms are known and are suitable for use as a probiotic in a litter product. Among them are strains selected from group N. streptococcus, such as Lactococcus lactis; group D Streptococcus, such as Streptococcus faecium; Pediococcus such as Pediococcus acidilactici, Pediococcus cerevisiae, and Pediococcus pentosaeceus; Propionibaeterium such as Propionibacterium shermanii and Propionibacterium freudenreichii; Leuconostoc; and Lactobacillus such as Lactobacillus acidophilus and Lactobacillus bulgaricus. Other nonspecific bacillus type organisms of compost and soil origin also are candidates. The probiotics comprise any one or combination of at least two of Bifidobacterium animalis, Lactobacillus or Enterococcus faecalis. Other probiotics are contemplated in the present invention. A preferred amount of bacteria in the granulated material is from about 1 to 25 wt. %.

An optional component for the granulated probiotic is food for the bacteria. Preferred foods are glucose and lactose.

The most common method for granulation is wet granulation. During the process, the powder undergoes a series of transformations including mixing with water, drying and grinding. In a preferred embodiment, the most suitable form is milled and sieved lactose, as it combines compaction and flow properties. It is critical that the drying take place at low temperature and as quickly as possible to protect the viability of the bacteria. It is recommended that the wet granules be dried in less than 20 minutes and at a temperature of less than 130° F.

Another method is dry granulation, which consists of two main steps: compression of the mixture of ingredients between two rollers, followed by breaking and grinding of the compacted product. Lactose can be in the crystalline form (monohydrate a or anhydrous p). It is what is known as a non-hygroscopic form as opposed to the amorphous form which is said to be hygroscopic. Anhydrous lactose meets these requirements, as it has excellent compaction capabilities due to its rough surface and high degree of fragmentation. Lactose monohydrate can also be used for dry granulation.

In order for granules to function it is necessary that the presence of the probiotics be physically near the spot where the cat urinates. The probiotic granules must be uniformly disbursed in the cat litter, and the particle size must fall within the average particle size for the cat litter substrate itself. In a preferred embodiment, the particle size of the cat litter ranges between a 12 and a 30 mesh screen size.

In a preferred embodiment, the granulated probiotic according to the invention is wet granulated using water containing a coating material. Other organic solvents, such as isopropyl alcohol damage the bacteria and are not suitable for the present method. For example, the water containing a coating material can be sprayed onto the non-hygroscopic material combined with the probiotic bacteria.

The granulated probiotic can be coated a variety of ways, including dipping and spraying. One method of coating is using a fluidized bed. The fluidized bed is formed when a quantity of a solid particulate substance is placed under appropriate conditions to cause a solid/fluid mixture to behave as a fluid. This is usually achieved by the introduction of pressurized fluid through the particulate medium. This results in the medium then having many properties and characteristics of normal fluids, such as the ability to free-flow under gravity, or to be pumped using fluid type technologies.

In one embodiment, the coating can be applied as a dry coating, if a dry granulation process has been used. A dry coating can be applied to a solid granulate material which has been wetted, or which is in a sticky state so as to adhere to the solid particulate material. This method includes the use of a commercial coating tumbler that rotates, tumbles, vibrates and/or otherwise agitates particles therein within that the outer surface of the particles are still sticky facilitating adherence of the powdered coating formulation to each particle. In a preferred method, the dry powder is applied to the solid granulate material after the material is wetted with an aqueous solution containing a cellulose ether, which acts as glue to hold the dry powder to the particle

In one preferred method of applying a coating, the coating formulation is applied using a liquid, such as water, and a pressurized gas, such as pressurized air, which not only helps vaporize or mist the coating formulation containing liquid but also helps agitate or move around the particles in a drum, container or enclosure, such as a commercial coating tumbler, which are being coated. In such a preferred method of applying a coating formulation onto uncoated particles, the non-hygroscopic material containing probiotics is mixed with a liquid, e.g., water, which can be sprayed from a nozzle together with compressed air into an enclosure, such as a drum or other container, which contains particles helping to agitate the particles and coat the particles with a minimum of disturbance or damage to the particles during coating. The drum or container in which the particles are disposed during such a coating step preferably is rotated, vibrated or otherwise agitated to help facilitate coating each particle.

The liquid coated onto the granules using solutions or slurries to adhere the coating to the granules. Preferably, the solution or slurry is a water soluble cellulose ether. Non-limiting examples of water soluble cellulose ethers include carboxy-C₁-C₃-alkyl celluloses, such as carboxymethyl celluloses; carboxy-C₁-C₃-alkyl hydroxy-C₁-C₃-alkyl celluloses, such as carboxymethyl hydroxyethyl celluloses; C₁-C₃-alkyl celluloses, such as methylcelluloses; C₁-C₃-alkyl hydroxy-C₁₋₃-alkyl celluloses, such as hydroxyethyl methylcelluloses, hydroxypropyl methylcelluloses (HPMC) or ethyl hydroxyethyl celluloses; hydroxy-C₁₋₃-alkyl celluloses, such as hydroxyethyl celluloses or hydroxypropyl celluloses (HPC); mixed hydroxy-C₁-C₃-alkyl celluloses, such as hydroxyethyl hydroxypropyl celluloses, mixed C₁-C₃-alkyl celluloses, such as methyl ethyl celluloses, or alkoxy hydroxyethyl hydroxypropyl celluloses, the alkoxy group being straight-chain or branched and containing 2 to 8 carbon atoms. The most preferred coatings are from HPC and/or HPMC.

Non-cellulosic coatings, such as polyvinyl pyrrolidone, alginate and starch are also suitable. In a preferred embodiment, polyvinyl pyrrolidone is used as a coating, because, as a coating it is water insoluble. Rather than dissolving, the coating gels and swells. This provides a sustained-release effect that allows the probiotic to be viable and useful for a longer time.

The coating may be applied as a solution or suspension. The process of preparing the coating solution differs, depending on which solution used to prepare it. For preparing solutions of hydroxypropylcellulose (HPC), commercially available as KLUCEL™ sold by Ashland Company or hydroxypropylmethylcellulose (HPMC) sold as HYPROMELLOSE™ by Dow Chemical Company, making an aqueous solution is typically a twostep process. The granulated HPC or HPMC is dispersed in water. After dispersion, the HPC or HPMC dissolves and forms a solution. For HPC and HPMC, the celluloses both readily dissolve in polar solvents such alcohols. In a referred embodiment, the coating solution to the solid absorbent is applied in 1:3 to a 1:30 range. More preferably, the coating solution is added to the solid absorbent in a 1:4 to a 1:25 range.

The preferred concentration of the coating material in the solution or suspension is in the range of from about 1 to 20 wt. %. Preferably PVP is present in the range of from about 5 to 15 wt. %. The preferred amount of coating solution applied to the dry mixture is from about 1:10 to 10:1. More preferred is from about 1:5 to 5:1.

### Example 1

### Preparing the Polyvinyl Pyrrolidone (PVP) Coating Solution:

The solution for wet coating was prepared as follows: A 10 wt. % solution of polyvinyl pyrrolidone was made by agitating 45.0 g water and adding 5.0 g PVP (Kollidon R 30) slowly. Mixing was continued for 5 minutes until there were no large chunks. The solution sat overnight. The solution was poured into a spray bottle.

### Wetting the Probiotic and Non-Hygroscopic Material:

The dry probiotic and dry non-hygroscopic material mixture (BCC Cultuur from Nobel Bio) was 10 wt. % probiotic bacteria and 90 wt. % crystalline lactose. About 30 to 40 g of the mixture was added to bowl of the stand mixer. The weight of the spray bottle was tared. Four squirts of the PVP coating solution was sprayed on the probiotic (about 10 g to 13 g) and non-hygroscopic mixture with stirring. NOTE: Do not spray so much such that the BCC Cultuur begins to clump. Weigh and record the amount of solution sprayed (amount “lost” from the tared spray bottle). NOTE: From the moment that the product is removed from the bowl to when it is placed in the heater/dehydrator should be no more than 6 minutes.

The weight of the heater/dehydrator tray and parchment paper is tared. Press the wet BCC Cultuur/PVP mixture through a No. 14 screen and onto the heater/dehydrator tray and parchment paper. This screening step works to provide smaller particles which will dry faster. Fast drying is critical, as excessive temperature and time will harm the bacteria.

### Drying the Wetted Material:

Weigh and record the amount of material put onto the tray. Place the tray into the heater/dehydrator at 122° F. Keep heating for 15-20 minutes. Remove from heat and sieve through a No. 16 sieve. The material that remains on the No. 16 sieve (the larger particles) is declared complete and set aside as completed product. Weigh both the completed product and the material passed through the No. 16 sieve and record.

### Screening the Granulated Material and Repeating:

The material that passes through the No. 16 shall be added back to the bowl for repeat wetting. Add additional probiotic and non-hygroscopic material mixture (BCC Cultuur) until the base amount in the bowl is 40 grams. Repeat the Wetting Step and on to continue to coat the product.

### The Final Granulated Product (wt. %)

| | |
|---|---|
| PVP | 4.78 |
| Crystalline Lactose | 84.70 |
| Probiotic bacteria | 9.52 |
| Total | 100.00 |

### Testing for Bacteria Viability:

A sample of the granulated product and a sample of the starting BCC Cultuur material were tested for bacteria viability. The results were: BCC Cultuur had 206×10⁶ cfu/g and granulated product had 130×10⁶ cfu/g. Although there was fewer bacteria colonies in the granulated material, there was still a significant amount of viable bacterial present after the granulation process.

### Testing for Slow Release and Dissolve Test:

A sample of the granulated product of Example 1 and a sample of the starting Cultuur lactose and probiotics mixture were tested as follows:

### Day 1:

1. Measure 10.00 g of the test material into a 100 mL container.
2. Pour in distilled water until the total volume reaches the 100 mL.
3. Record the date and time that the water was added to the container.
4. Allow to sit open overnight.

### Day 2:

1. Prepare a No. 100 mesh screen with an appropriate catch. Prepare a wax paper, determining and recording the tare of the wax paper.
2. At 24 h after water addition (Day 1), pour all of the contents of the 100 mL container onto the screen. If material remains in the container, scrape onto the screen. Drain for 5 minutes.
3. Place all product captured on the screen onto the wax paper. Scrape to get all material onto the wax paper.
4. Put the wax paper into a heater/dehydrator set to 122° F. and for 24 h. Record the date and time that the product went into the heat.

### Day 3:

1. After 24 h, take the wax paper/product out of the heater/dehydrator.
2. Weigh the wax paper/product and subtract the tare of the wax paper. Record the final weight. Calculate the wt. % recovered.

### Test Results:

The results of the dissolution test was that the Culture mixture completely dissolved and no solids were recovered at the end of the test. This indicates an immediate release of the probiotics when wetted. The granulated product from Example 1 indicated a recovery of 2.55 g of dry solids were recovered from the 10.0 g that were initially tested. The 25.5 wt. % recovery indicates that dissolution of the granulated product is slowed and that the release of the probiotics will be slowed.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A cat litter comprising at least one solid absorbent material and at least one granulated probiotic, wherein the at least one granulated probiotic comprises at least one probiotic and at least one non-hygroscopic binder.

2. The cat litter of claim 1, wherein the at least one non-hygroscopic binder is selected from the group consisting of crystalline lactose, hydroxypropylmethylcellulose, hydroxypropylcellulose, hydroxyethylcellulose, methylcellulose and ethylcellulose.

3. The cat litter of claim 2, wherein the at least one granulated probiotic does not contain hygroscopic clay.

4. The cat litter of claim 1, wherein the absorbent material is selected from the group consisting of clays, silica gels, woods, agricultural products, pumice, absorbent foamed materials, and combinations thereof.

5. The cat litter of claim 4, wherein the absorbent material is granulated clay.

6. The cat litter of claim 5, wherein the granulated clay is sodium bentonite.

7. The cat litter of claim 6, wherein the at least one non-hygroscopic binder is crystalline lactose.

8. The cat litter of claim 7, wherein the crystalline lactose is present in the granulated probiotic in the amount of greater than 50 wt. %.

9. The cat litter of claim 8, wherein the granulated probiotic contains a coating.

10. The cat litter of claim 9, wherein the coating is polyvinyl pyrrolidone.

11. A method of making a cat litter containing a probiotic comprising granulating a probiotic,
wherein the dry probiotic is combined with a dry non-hygroscopic material to form a dry mixture;
wherein the dry mixture is wetted with an aqueous liquid in a weight ratio of about from 1:1 to 1:10 and mixed;
wherein the wetted mixture is sieved to reduce the particle size for drying;
wherein the particles are dried for less than 20 minutes at less than 130° F.; and
wherein the dried particles are sieved to form the desired size granule;
and combining the granulated probiotic with an absorbent material to form the cat litter.

12. The method of claim 11, wherein the at least one non-hygroscopic binder is selected from the group consisting of crystalline lactose, hydroxypropylmethylcellulose, hydroxypropylcellulose, hydroxyethylcellulose, methylcellulose and ethylcellulose.

13. The method of claim 12, wherein the at least one granulated probiotic does not contain hygroscopic clay.

14. The method of claim 13, wherein the at least one non-hygroscopic binder is crystalline lactose.

15. The method of claim 14, wherein the crystalline lactose is present in the granulated probiotic in the amount of greater than 50 wt. %.

16. The method of claim 15, wherein the granulated probiotic is coated.

17. The method of claim 16, wherein the coating is polyvinyl pyrrolidone.

18. A granulated probiotic, comprising at least one probiotic and at least one non-hygroscopic binder,
wherein the at least one non-hygroscopic binder is selected from the group consisting of crystalline lactose, hydroxypropylmethylcellulose, hydroxypropylcellulose, hydroxyethylcellulose, methylcellulose and ethylcellulose; and
wherein the at least one granulated probiotic does not contain hygroscopic clay.

19. The granulated probiotic of claim 18, wherein the at least one granulated probiotic does not contain hygroscopic clay;
wherein the at least one non-hygroscopic binder is crystalline lactose; and
wherein the crystalline lactose is present in the granulated probiotic in the amount of greater than 50 wt. %.

20. The granulated probiotic of claim 19, wherein the granulated probiotic is coated, and wherein the coating is polyvinyl pyrrolidone.
